(19) United States
(12) Patent Application Publication
(10) Pub. No.: US 2010/0098134 A1
(43) Pub. Date: Apr. 22, 2010

(54) METHOD AND APPARATUS FOR USING A SPREAD SPECTRUM INTERMEDIATE FREQUENCY CHANNEL WITHIN AN ELECTRONIC DEVICE

(76) Inventor: Glenn Dixon, West Point, UT (US)

Correspondence Address: BATEMAN IP LAW GROUP, P.O. BOX 1319, SALT LAKE CITY, UT, 84110, US

(21) Appl. No.: 12/256,291

(22) Filed: Oct. 22, 2008

(51) Int. Cl. H04B 1/713; H04B 1/69

(52) U.S. Cl. 375/133; 375/130; 375/E01.033

(57) ABSTRACT

An input signal to a radio device is received and has its frequency spread prior to processing the signal to allow the performance benefits of a spread spectrum signal. After processing, the signal is despread by analog or digital processing to create an output signal. The spreading and despreading functions can be implemented with known techniques or a truly random bit sequence.

### RELATED APPLICATIONS

The present application claims the benefit of U.S. Provisional Application Ser. No. 61/000,118, filed Oct. 24, 2007, which is expressly incorporated herein by reference.

### BACKGROUND OF THE INVENTION

1. The Field of the Invention

The present invention relates to improving performance of transmitting and receiving radio devices. More specifically, the invention relates to using a spread spectrum local oscillator in combination with a mixer to realize a spread spectrum intermediate frequency within the radio device.

2. State of the Art

Radio devices are often designed with multiple functional blocks to optimize cost and performance. These functional blocks may be circuits or electronic components which perform a specified function and which may be used for multiple similar applications. Receivers are designed to receive signals from a communications channel and prepare them for further processing. Transmitters are similarly designed to prepare and transmit the desired signal into a communications channel. Frequently transmitters and receivers can share functional blocks, such as amplifiers or filters, to reduce complexity and cost. When transmitter and receiver circuitry is shared in this manner, the device is known as a transceiver. Mixers and local oscillators can be used convert the input signal to a different frequency that is more practical for processing or transmitting. Modem radio devices frequently employ analog to digital (A/D) converters and digital signal processors (DSP), which permit complicated signal processing function to be implemented in the DSP firmware at very low cost.

While the processing done by these functional blocks is necessary to the functioning of the radio device, they often introduce distortion or interference due to their inherent limitations. A mixer may allow harmonic frequencies of the local oscillator to interfere with the desired signal. If the mixer is connected directly to an antenna, leakage from the local oscillator may be transmitted by the antenna as an unwanted tone to nearby receivers. Further, the conversion of the signal to an intermediate frequency by the mixer may result in the creation of an image frequency which can cause interference. In some receivers, the filtering of the image frequency can require complex and costly circuitry. Amplifiers and filters will also typically introduce some distortion to the desired signal. If the maximum input voltage of an analog to digital converter is exceeded (perhaps due to a large interfering signal), clipping of the signal may occur. The distortion and interference introduced in these ways has an undesirable effect on the radio device's performance.

For communication devices such as wireless radio receivers and transmitters, communications are sent through the atmosphere or space. A recent adaptation for improved performance in transmitting communications through space is the use of spread spectrum techniques, which are commonly employed in cell phone and Global Positioning Satellite systems. These systems obtain improved channel performance by transmitting a signal whose spectrum has been spread, or widened over frequencies larger than those required to by the basic communication bandwidth.

Spread spectrum channels have several advantages over traditional narrowband signals. Several spread spectrum signals can be simultaneously transmitted or received in the same frequency spectrum. Spread spectrum signals are also less susceptible to interference, have better signal to noise ratios, and suffer reduced distortion from strong nearby signals.

It would be desirable to realize the advantages of spread spectrum signals in communication channels other than space. The use of a spread spectrum channel communications implemented entirely within the electronics of a transmitter or receiver could improve the radio device's dynamic range and selectivity, common measures of radio performance. These measures relate to how well the device handles sources of distortion and noise, including those discussed previously.

There is thus a need for electronics devices which have improved performance such as improved dynamic range and selectivity and reduced sensitivity to distortion and noise through the use of spread spectrum techniques within the transmitter or receiver of a radio device.

### SUMMARY OF THE INVENTION

It is an object of the present invention to provide a method and apparatus for implementing spread spectrum techniques within the electronics of a radio receiver or transmitter to improve the radio device's performance.

According to one aspect of the invention, an electronic device is provided which takes an incoming narrowband signal, such as a radio signal, and spreads its spectrum preparatory to further processing. The device may employ one of many signal spreading techniques, including frequency hopping, pseudo-random bit sequencing, frequency modulation, phase modulation, or even modulation of the signal with true random noise. The device then further processes the signal (for example, through analog or digital filtering and amplification), taking advantage of the spread spectrum characteristics such as increased immunity to harmonics, better dynamic range, and image rejection. The device then despreads the signal to an appropriate frequency for transmission or use by a radio device.

These and other aspects of the present invention are realized in a method and apparatus for using spread spectrum techniques within the electronics of radio receivers or transmitters as shown and described in the following figures and related description.

### BRIEF DESCRIPTION OF THE DRAWINGS

Various embodiments of the present invention are shown and described in reference to the numbered drawings wherein:

FIG. 1 shows a block diagram of a simple receiver illustrating an embodiment of the present invention;

FIG. 2 shows a local oscillator that can be used to randomly spread the spectrum of the signal within the communication channel;

FIG. 3 shows a diagram of an electrical circuit of the present invention, illustrating the spreading local oscillator;

FIG. 4 shows a diagram of an electrical circuit of the present invention, illustrating the antenna, mixer, and amplification stages; and

FIG. 5 shows a diagram of an electrical circuit of the present invention, illustrating the digital signal processor with analog to digital conversion capabilities integrated within the processor.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

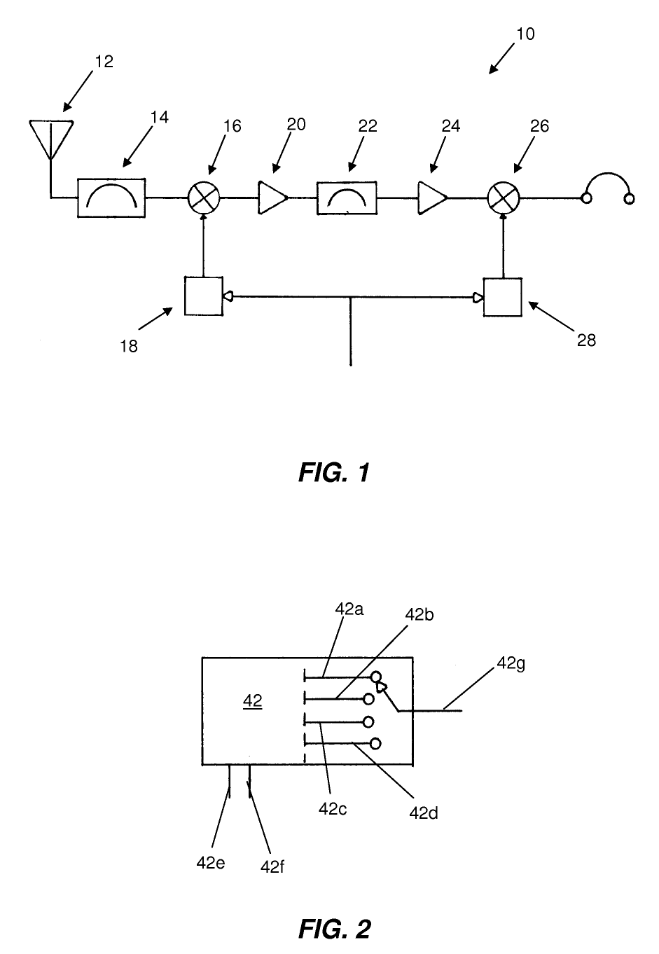

Turning now to FIG. 1, a block diagram of a simple receiver implementing the present invention is shown, indicated generally at 10. A radio frequency (RF) signal is received by the antenna 12 of the receiver 10. A bandpass filter 14 limits the received signal to a narrower frequency band of interest. The signal is then spread from the narrowband received signal to a spread spectrum intermediate frequency (IF) through the use of a mixer 16 and a local oscillator 18.

The local oscillator 18 employed is not a traditional fixed frequency oscillator as is found in most receivers, but is an oscillator configured to generate a spread spectrum signal. The output frequency of the spreading local oscillator 18 is varied by techniques such as frequency hopping, by generating a pseudo-random bit sequence, by frequency modulation (FM), by phase modulation (PM), or by modulating the signal with true random noise. As this varied oscillator signal is mixed with the narrowband input signal by the mixer 16, the signal is spread across a broader spectrum.

This spread signal is then processed further, preparing the signal for use by the radio device. In the simple receiver shown in FIG. 1, processing is done through analog stages such as amplifiers 20, 24 and filters 22. In a receiver implemented with an A/D converter and a DSP, the spread spectrum signal could instead be fed directly into the A/D converter. The digital signal output by the A/D converter could then be processed (amplified and/or filtered) within the DSP firmware rather than through the analog hardware shown in FIG. 1. Those skilled in the art will appreciate that the signal may be further mixed to other intermediate frequencies for further processing of the signal through additional amplifiers, filters, etc.

Once the spread signal has been processed, it is despread by mixer 26 and local oscillator 28. The despreading local oscillator 28 is modulated by the identical spreading function used by the spreading local oscillator 18 so the signals are spread and despread properly. The base frequency of the despreading local oscillator 28, however, may be different from the spreading local oscillator 18, which would result in another shift in the signal's frequency to an appropriate output signal frequency. In FIG. 1, the second mixer 26 mixes the signal to a baseband frequency for audio amplification and listening. It will be appreciated that in systems implementing A/D converters and DSP, the despreading function can be performed in the DSP firmware rather than through the use of a discrete mixer 26 and local oscillator 28.

One advantage of using the spread spectrum processing of a signal within a RF receiver or transmitter is an increased immunity to received harmonics. Most receivers use a mixer to convert the received signal into an intermediate frequency signal more suited for processing. The mixer convolves the received signal's spectrum with the local oscillator's spectrum, but the local oscillator's spectrum usually contains harmonics of its base frequency. For example, a 5 MHz local oscillator 18 feeding a passive mixer 16 will convert a 6 MHz signal or a 4 MHz signal to 1 MHz, but because the local oscillator 18 and mixer 16 transfer function responds to the oscillator's third harmonic (15 MHz), it will also convert any 16 MHz or 14 MHz signal present at the input to 1 MHz. Thus strong signals at these frequencies may be convolved with and interfere with the desired signal.

In the present invention, if the local oscillator signal is spread (for example, to a bandwidth of 100 KHz), the bandwidth of the third harmonic signal will be spread to a bandwidth three times as wide (300 KHz). Filtering can then be used to remove the edges of the wider spectrum of the harmonic signal and still pass the desired 100 KHz signal that was originally at 4 MHz or 6 MHz. Further, the despreading mixer 26 will correctly despread the desired signal, but the undesired harmonic response that was spread over 300 KHz by the first mixer 16 will not be despread by the second mixer 26. The undesired harmonic signal is thus largely filtered out, and the remaining unfiltered signal is spread across a broader spectrum, primarily into the noise floor of the receiver. This remaining undesired signal can be filtered out by the use of an additional narrowband filter. Thus, the receiver's response to unwanted local oscillator harmonics is greatly reduced.

A further advantage to using spread spectrum techniques within the receiver or transmitter is better dynamic range. Dynamic range is a ratio of the largest to the smallest signal strengths capable of being received simultaneously without negative effects from circuit limitations such as blocking and intermodulation distortion. In an RF device using the present invention, any distortion generated by the signal processing stages between the spreading mixer 16 and despreading mixer 26 will be spread as well, but not well-correlated with the input spread spectrum signal set. The distortion will remain spread when the desired signal is despread, and will contribute to the system noise floor, usually in a minor way.

Devices employing A/D converters are subject to the inherent distortion within the A/D converter. This distortion can be a result of nonlinear steps, nonmonotonic transfer characteristics, and intermodulation distortion. These distortions are reduced in the same manner as the analog system described above.

Additionally, in a traditional narrowband receiver a few strong signals within the input filter's 14 passband can generate false signals via distortion and blocking in the input mixer and later stages. The spread spectrum input mixer 16 will spread the spectrum of these powerful undesired signals over a wider bandwidth, which reduces the peak voltages and currents of the IF signal. This reduction of the peak voltage allows the device to effectively receive a larger input signal without distortion, resulting in increased dynamic range in these stages.

If the receiver utilizes an A/D converter to allow digital processing of the signal, the A/D converter will have a maximum voltage limit on the input signal. If the input voltage exceeds this limit, the signal will be clipped or otherwise distorted. This limitation, along with the noise floor and resolution of the A/D converter, determines the dynamic range of the device. A single strong undesired signal may cause the input voltage limit to be exceeded, resulting in clipping and distortion. In a spread spectrum device, this strong signal's spectrum is spread, resulting in a lower peak voltage and decreasing the likelihood of the input voltage limit being exceeded. Thus, as long as the A/D converter has sufficient bandwidth to convert the desired signal's spread spectrum, dynamic range is increased for the device.

An additional advantage of the present invention is improved image rejection. When a mixer 16 converts the received signal to an appropriate intermediate frequency for processing, a second signal called the image frequency is often generated. The image frequency is undesirable and usually must be filtered out in some manner. Image rejection is a measure of how sensitive the receiver is to the desired frequency compared to how sensitive it is to the unwanted image frequency.

The simplest direct conversion receivers use a single mixer to convert signals directly to a baseband frequency, such as audio. The input mixer in this type of receiver cannot separate the image frequency from the desired frequency, as often both frequencies fall within the baseband range. To compensate for this deficiency, complex and sensitive phasing-type receiving systems must be employed which require two separate receive channels with carefully matched hardware. If the phases and amplitudes of both receive channels is not carefully controlled, image frequency rejection will not be good.

In the spread spectrum channel of the current invention, the desired intermediate frequency and the undesired image frequency are encoded differently in the spread spectrum signal, depending on the phase of the spreading function. By knowing the phase of the spreading function at all times, the despreading can be implemented such that only the desired frequency is despread. The unwanted image frequency is effectively rejected without the complexity and cost of using multiple receive channels.

Further, when a mixer in a direct conversion receiver is connected directly to an antenna (or connected through a filter or matching network to the antenna), leakage from the local oscillator is of a frequency that it may pass through back to the antenna. This leakage may result in an unwanted tone being transmitted, which can interfere with other nearby receivers. By using a local oscillator 18 modulated to a spread spectrum, this unwanted leakage signal is spread over a wider spectrum and is less detectible on nearby receivers.

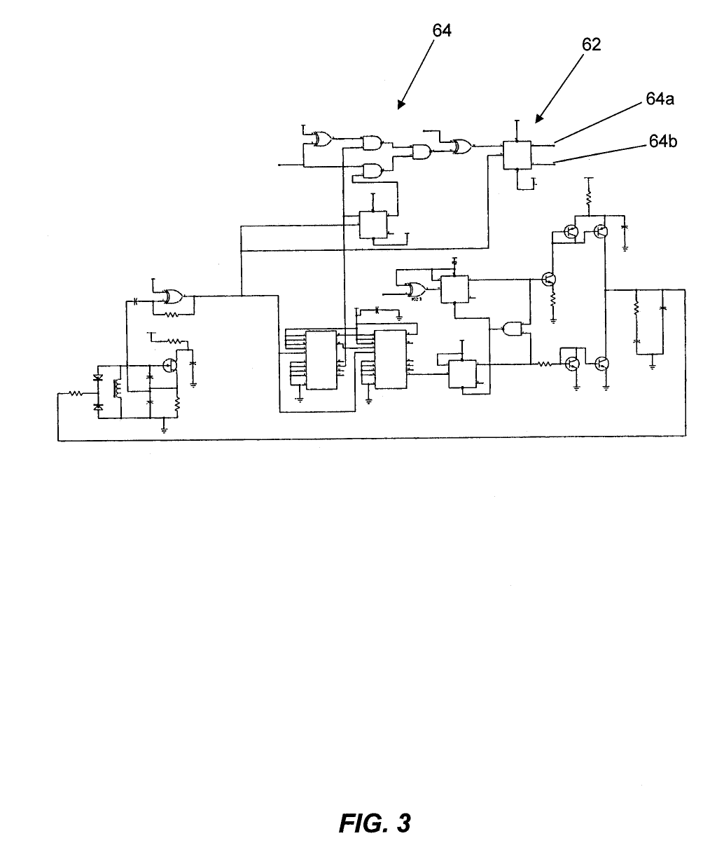

Turning now to FIG. 2, an embodiment of the local oscillator 42 used to spread and despread the signal is shown. In a spread spectrum channel through space, some method must be used to assure the spreading function in the transmitting device and the despreading function in the receiving device are identical and synchronized. Thus, the spreading function must be known and predictable, and some means of synchronizing the functions is necessary. In the present invention the spreader and despreader are contained within the same device, and thus the exact same signal can be used for both spreading and despreading the desired signal. Therefore a truly random method may be used to spread the signal instead of a controlled frequency hopping or pseudo-random generation technique.

In FIG. 2, the signal is spread using a phase-shift keying (PSK) modulation technique, which is known to work well for transmitting data. The local oscillator 42 contains four output signals 42a, 42b, 42c, 42d, which have a phase shift of 0 degrees, 90 degrees, 180 degrees, and 270 degrees respectively from a reference signal. The bottom two bits 42e, 42f (two of the output pins) of an A/D converter, which is frequently integrated within a DSP, are fed back to the local oscillator 42. The binary output value of these two bits, having four possible values (combinations of HI and LO states on the output pins), is used to select which of the four phase shifted output signals from the local oscillator 42 will be transmitted through the local oscillator output 42g and thus become the next phase of the PSK spread spectrum signal. The result is a truly random spreading function. It will be appreciated that other random number generation techniques may be used as well. In this embodiment, the DSP sets the spreading local oscillator's 42 phase in hardware, and also programs the firmware despreading local oscillator, permitting perfect spreading/despreading with a truly random signal. Delays and equalization effects in filters, amplifiers, and the A/D converter in the spread spectrum channel may require a filter that removes these effects in the DSP firmware.

Turning now to FIG. 3, a diagram of an exemplary electrical circuit of the present invention is shown. Synthesizer 62 generates a local oscillator signal whose phase can be instantly switched between 0, 90, 180, and 270 degrees in a manner similar to the device shown in FIG. 2. The phase shift of the output signal of the synthesizer 62 is set by the logic gates shown generally at 64. The input signals controlling the output of the logic gates 64 are two bits (labeled 0/180 and 90/270) which are generated by the A/D converter output, thus resulting in a truly random spread spectrum modulation.

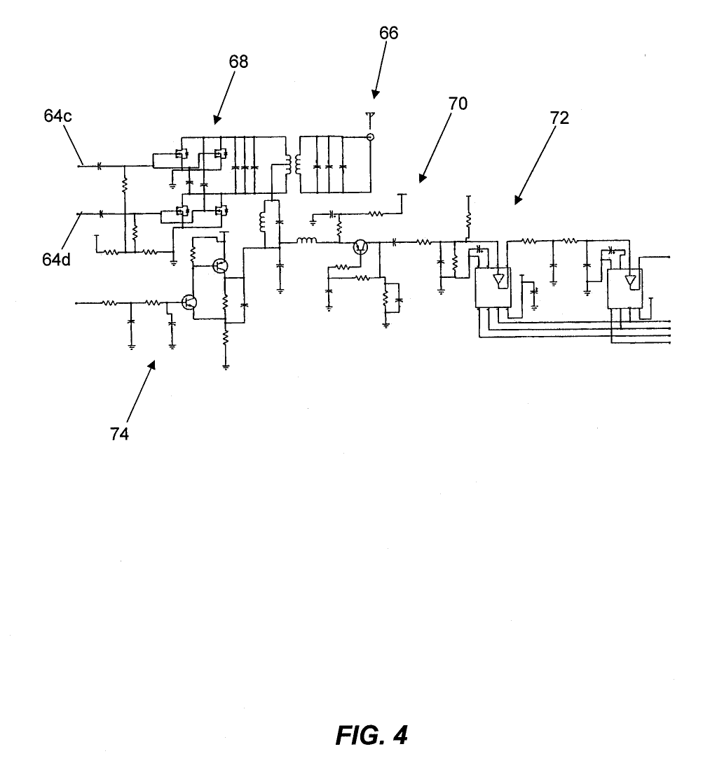

Turning to FIG. 4, an additional portion of the diagram of the electrical circuit of the present invention referenced in FIG. 3 is shown. Electrical connections 64a, 64b of FIG. 3 are connected to electrical connections 64c, 64d of FIG. 4, respectively. FIG. 4 shows a transceiver implemented with the present invention. Antenna 66 is used to receive the desired signal when the transceiver is functioning as a receiver, or to transmit the generated signal when the transceiver is functioning as a transmitter. When operating as a receiver, the signal received on antenna 66 is mixed with the local oscillator output from the synthesizer (62 in FIG. 3) by the mixer 68. The mixer 68 consists of a series of field effect transistors (FETs), whose non-linear characteristics allow the mixing of the input signal and the spreading local oscillator signal to create an intermediate, spread spectrum signal. This spread spectrum signal is then processed through amplification stages 70, 72 to prepare the signal for processing within a DSP.

When the transceiver is operating as a transmitter, the output signal generated by the device is amplified by the amplifier indicated generally at 74. The amplified output signal is then transmitted through antenna 66.

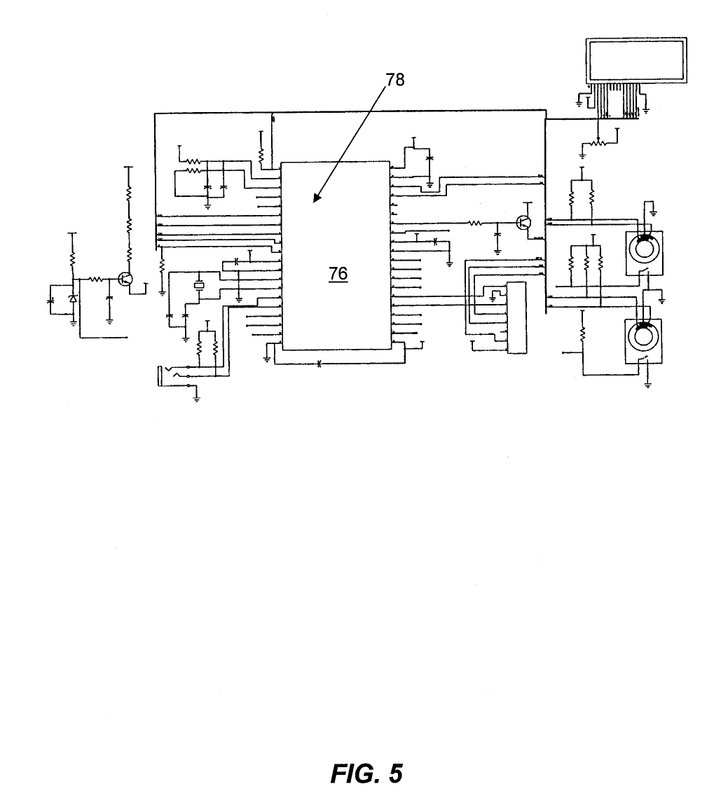

Turning to FIG. 5, an additional portion of the diagram of the electrical circuit of the present invention referenced in FIG. 3 and FIG. 4 is shown. FIG. 5 shows a DSP 76 with an integrated A/D converter indicated generally at 78. When the transceiver is operating as a receiver, the spread spectrum intermediate signal is received by the input of the A/D converter 78. The DSP 76 firmware may further digitally process the signal, including amplification and filtering of the signal. The DSP 76 firmware then despreads the spectrum of the signal through the use of a firmware mixer function, including potentially converting the signal to an appropriate frequency to be output, for example to a baseband frequency for audio listening and amplification.

When the transceiver is operating as a transmitter, the input signal is fed into the A/D converter 78 integrated within the DSP 76. The DSP 76 firmware then processes the signal and outputs a signal to the transmitter amplifier (74 in FIG. 4). The signal is then transmitted using the antenna (66 in FIG. 4). When implementing a spread spectrum channel within the electronics of the transceiver in this manner, the advantages of spread spectrum techniques (including better dynamic range, increased immunity to received harmonics, and better image rejection) are realized and result in increased performance of the radio device.

Although the above description has detailed the implementation of spread spectrum in combination with signal processing within a receiver channel, it will be appreciated that the spread spectrum processing methods discussed herein may be similarly implemented within signal streams or signal channels of other electronic devices. In particular, the spread spectrum techniques may be implemented within instrumentation signal channels or other electronic devices which perform signal processing such as data acquisition electronics, etc.

There is thus disclosed a method and apparatus for using a spread spectrum channel within the electronics of a radio device. It will be appreciated that numerous changes may be made to the present invention without departing from the scope of the claims.

What is claimed is:

1. A method of processing a signal comprising:
receiving a narrowband input signal;
spreading the frequency of the input signal over a broader frequency spectrum than the narrowband input signal;
processing the input signal while its frequency is spread; and
despreading the frequency of the input signal to create an output signal.

2. The method of claim 1, wherein the spreading of the frequency of the input signal comprises mixing the input signal with a first variable local oscillator signal by the use of a first mixer.

3. The method of claim 2, wherein the despreading of the frequency of the input signal comprises mixing the input signal in its spread state with a second variable local oscillator signal by the use of a second mixer to create an output signal.

4. The method of claim 3, wherein the output signal has a different frequency than the input signal.

5. The method of claim 3, wherein the frequency of both the first and the second local oscillator's signals are varied using a random bit sequence.

6. The method of claim 3, wherein the frequency of both the first and the second local oscillator's signals are varied using a frequency hopping spread spectrum technique.

7. The method of claim 3, wherein the frequency of both the first and the second local oscillator's signals are varied using a pseudo-noise bit sequence.

8. The method of claim 3, wherein the frequency of both the first and the second local oscillator's signals are frequency modulated.

9. The method of claim 3, wherein the phase of both the first and the second local oscillator's signals are phase modulated.

10. The method of claim 3, wherein processing the input signal comprises amplifying, filtering, or mixing the input signal subsequent to the input signal being spread by the first mixer and prior to the input signal being despread by the second mixer.

11. The method of claim 10, wherein the step of despreading comprises filtering to alter the spread input signal, attenuating one sideband of the spread input signal and despreading the other sideband of the input signal.

12. The method of claim 2, wherein the step of processing the input signal comprises converting the input signal from an analog signal to a digital signal and processing the signal through a digital signal processor.

13. The method of claim 12, wherein the step of despreading the frequency of the input signal is accomplished through a digital signal processor.

14. The method of claim 13, wherein the output signal has a different frequency than the input signal.

15. The method of claim 13, wherein the step of despreading comprises filtering to alter the spread input signal, attenuating one sideband of the spread input signal and despreading the other sideband of the input signal.

16. A device for processing a signal of a spread spectrum channel comprising:
a local oscillator which outputs a signal whose phase can be switched between 0, 90, 180, and 270 degrees relative to a reference signal;
a mixer which mixes an input signal with the output of the local oscillator to spread the spectrum of the input signal over a broader frequency spectrum;
an analog to digital converter that converts the spread spectrum input signal to a digital signal; and
a digital signal processor that despreads the input signal and creates an output signal.

17. The device of claim 16, wherein the phase shift of the local oscillator's output signal is controlled by two bits of the analog to digital converter output.

18. The device of claim 17, further comprising amplifiers to process the spread spectrum input frequency.

19. The device of claim 18, wherein at least some of the amplifiers are implemented within the digital signal processor.

20. The device of claim 17, further comprising filters to process the spread spectrum input frequency.

21. The device of claim 20, wherein at least some of the filters are implemented within the digital signal processor.

22. The device of claim 21, wherein a filter implemented within the digital signal processor's firmware alters the despreading of the input signal, allowing one sideband of the spread input signal to pass through the filter and blocking the other sideband.

23. The device of claim 21, wherein a filter implemented within the digital signal processor's firmware compensates for signal processing delays and equalization effects.

24. The device of claim 16, wherein the device is located within a radio device's receiver signal path.
